(19) United States
(12) Patent Application Publication
(10) Pub. No.: US 2013/0073429 A1
(43) Pub. Date: Mar. 21, 2013

(54) SECURE COMMERCE WITHIN ELECTRONIC BANKING

(71) Applicants: Siva G. Narendra, Portland, OR (US); Donald Allen Bloodworth, Camas, WA (US); Todd Raymond Nuzum, Omaha, NE (US); Prabhakar Tadepalli, Bangalore (IN)

(72) Inventors: Siva G. Narendra, Portland, OR (US); Donald Allen Bloodworth, Camas, WA (US); Todd Raymond Nuzum, Omaha, NE (US); Prabhakar Tadepalli, Bangalore (IN)

(73) Assignee: TYFONE, INC., Portland, OR (US)

(21) Appl. No.: 13/235,456

(22) Filed: Sep. 18, 2011

(51) Int. Cl. G06Q 30/06; G06Q 40/02

(52) U.S. Cl. 705/26.41; 705/42

(57) ABSTRACT

Users perform in-application purchases when logged in to an electronic financial application. User funds are transferred into an intermediate account at the user's financial institution, and merchants are paid from a guaranteed account at a separate financial institution. Non-real-time settlement is performed between the intermediate account and the guaranteed account.

### FIELD

The present invention relates generally to electronic banking, and more specifically to secure electronic banking

### BACKGROUND

In today's electronic commerce environment, a user typically accesses a merchant's website to purchase a product. The user then typically enters a payment identity (e.g., credit card) to pay for the purchase. Merchants typically store payment identities for many different users, and some merchants willingly store multiple payment identities for each user, thereby creating large databases of payment identities vulnerable to security breaches.

### BRIEF DESCRIPTION OF THE DRAWINGS

FIG. 1 shows an electronic banking system with in-application commerce between a banking user and a merchant;

FIG. 2 shows an electronic banking system with in-application commerce between a banking user and multiple merchants using a consolidator;

FIG. 3 shows an electronic banking system with in-application commerce between multiple banking users and multiple merchants using multiple consolidators;

FIG. 4 shows an electronic banking system resident at a user's financial institution (FI);

FIG. 5 shows a hosted electronic banking system that communicates with multiple different financial institutions;

FIGS. 6 and 7 show electronic financial systems in accordance with various embodiments of the present invention;

FIGS. 8 and 9 show examples of user electronic devices;

FIG. 10 shows an electronic banking system with in-application purchases of gift cards;

FIGS. 11-19 show mobile device displays for in-application gift card purchases; and

FIGS. 20-22 show flowcharts of methods in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

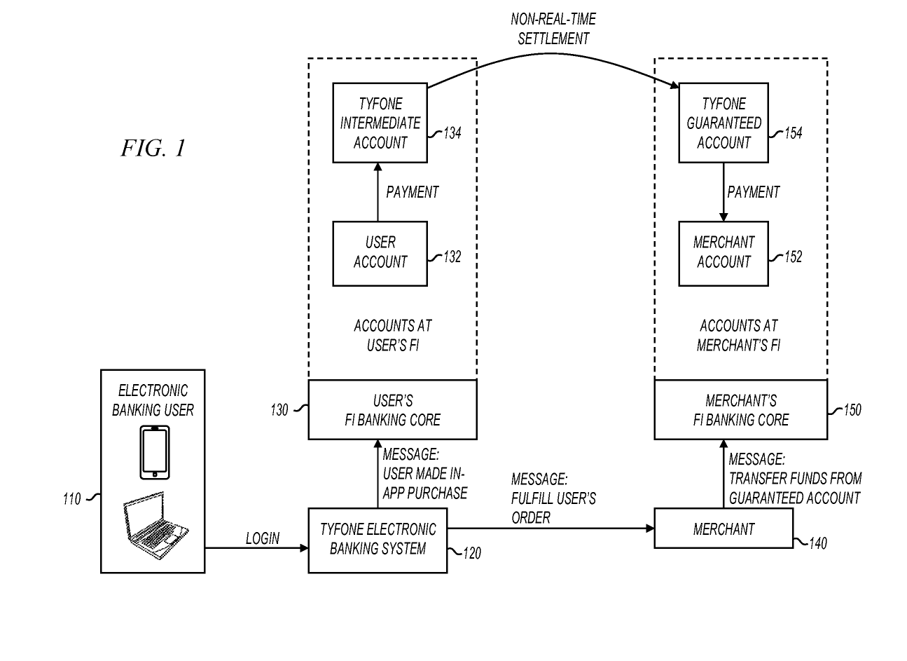

FIG. 1 shows an electronic banking system with in-application commerce between a banking user and a merchant. In operation, electronic banking system 120 receives a login request from an electronic banking user 120. As used herein, the term “electronic banking user” refers to a user of any electronic device capable of logging in to a service. For example, an electronic banking user may be a user of a desktop computer, a laptop computer, a tablet computer, a mobile phone, or the like. Further a user may be a member of a financial institution, such as a credit union or a bank.

After receiving a login request, electronic banking system 120 authenticates the user. In some embodiments, authentication is performed using a username and password, and in other embodiments, authentication also detects the presence of a hardware token present at the electronic banking user. For example, authentication may require that a user's electronic device have a smartcard secure element that is mapped to that user's identity. The smartcard secure element may be resident in the user's electronic device or may be resident on removable media. For example, in some embodiments, a smartcard secure element may be resident on a microSD memory card that is inserted in a memory card slot of the user's electronic device.

Electronic banking system 120 is an example of an electronic financial application that accepts user logins and interfaces with a financial institution (FI). As shown in FIG. 1, electronic banking system 120 may interface with the banking core at the user's financial institution. In these embodiments, electronic banking system 120 may provide internet banking services, mobile banking services, or the like. In addition to these services, electronic banking system 120 also provides in-application commerce services. As used herein, the term “in-application commerce” refers to transactions that take place within the application environment provided by the electronic banking system. The application environment may be an applet that runs in a web browser (a “thin” application), or may be an application that is downloaded onto the user's electronic device (a “thick” application).

When a user is logged in to electronic banking system 120, one or more products are made available for in-application purchase from one or more merchants. When the user makes an in-application purchase, electronic banking system 120 sends a message to the user's financial institution banking core 130. Message to the banking core 130 can happen directly from the electronic banking system 120 or indirectly through other electronic banking systems depending on the implementation within a given financial institution. In response, funds are transferred from the user's account 132 at the financial institution to an intermediate account 134 at the same financial institution. In some embodiments, the intermediate account is not owned or controlled by the merchant from whom a purchase is being made. Electronic banking system 120 also sends a message to the merchant 140. In response to the message to the merchant, the merchant effects a transfer of funds from a guaranteed account 154 to the merchant's account 152 at the merchant's financial institution 150. Message to the banking core 150 can happen directly from the merchant 140 or indirectly through other electronic banking systems depending on the implementation within a given financial institution.

For each in-application purchase made by the user, an appropriate amount is debited from the user's account 132, and an appropriate amount is credited to the merchant's account 152, although there is no direct transfer from the user to the merchant. The two amounts may or may not be equal. For example, the amount credited to the merchant account might be less than the amount debited from the user's account 132. The difference may be credited to one or more financial institutions or to one or more service providers to pay for the in-application commerce service.

Funds sufficient to cover expected in-application purchases are maintained in guaranteed account 154. In some embodiments, these funds are maintained by a service provider that also provides the electronic banking system 120. Merchants are paid in real-time from the guaranteed account, and user's pay in real-time into the intermediate account. Settlement between the intermediate account 134 and the guaranteed account 154 are performed in non-real-time. For example, settlement may occur nightly, weekly, or on any other schedule.

By using electronic banking system 120 with in-application commerce, payment identities (e.g., credit card info) need not be replicated at merchants because the user's financial institution effects payment from the user's account directly, and the merchant is paid from a guaranteed account at its own financial institution. Further, traditional payment networks that charge for real-time settlement are also not necessary.

Merchant 140 may fulfill the order in any manner without departing from the scope of the present invention. For example, physical goods may be shipped to an address specified by the user. Also for example, electronic goods (e.g., coupons, vouchers, gift cards) may be sent electronically to any entity specified by the user, including the user himself.

In some embodiments, the intermediate account 134 and the guaranteed account 154 are owned or controlled by the entity providing electronic banking service 120. For example, a provider of electronic banking services may also fund one or more guaranteed accounts 154 at different financial institutions to pay merchants. Also for example, the provider of electronic banking services may also perform the non-real-time settlement between the intermediate account 134 and guaranteed account 154.

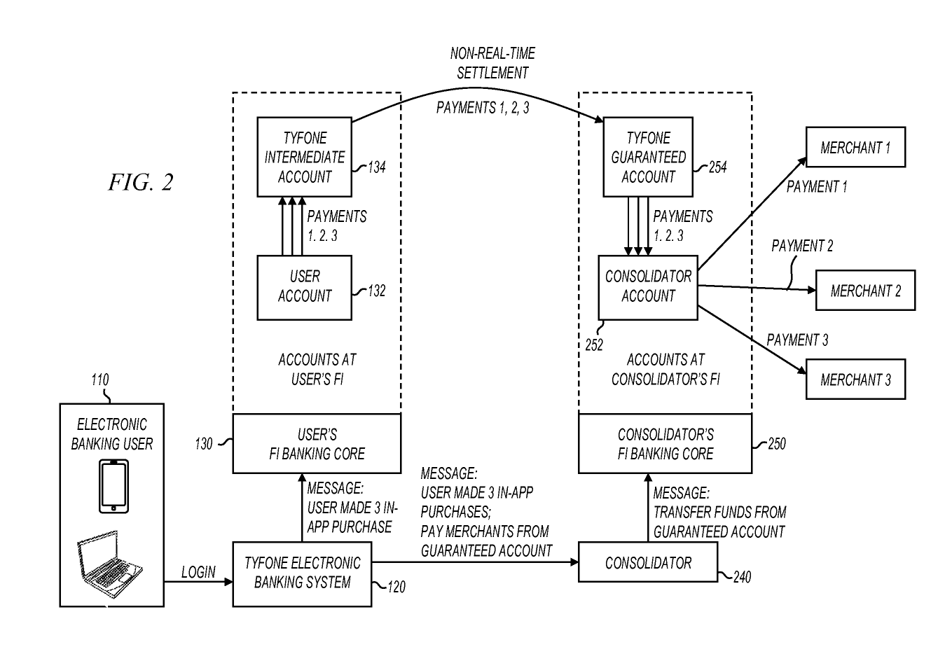

FIG. 2 shows an electronic banking system with in-application commerce between a banking user and multiple merchants using a consolidator. In the example shown in FIG. 2, a single electronic banking user 110 makes three in-application purchases; one each from three different merchants. When the purchases are made, electronic banking system 120 sends a message to the user's financial institution to alert the financial institution to debit the user's account 132. Payments for all three in-application purchases are made by debiting user account 132 and crediting the intermediate account 134.

Electronic banking system 120 also sends a message to a consolidator 240 alerting the consolidator that the user made three purchases and requesting the consolidator to transfer funds from the guaranteed account 254 to the consolidator's account 252 at the consolidator's financial institution. The consolidator can then make real-time or offline or have already made in advance payments to the merchants in order to fulfill the purchases depending on their agreement with each of the merchants.

As used herein, the term “consolidator” refers to an entity that provides a service to consolidate interfaces from multiple merchants into one virtual merchant (the consolidator). For example, consolidator 240 may provide an application programming interface (API) to electronic banking system 120 that allows purchases from multiple merchants using one interface.

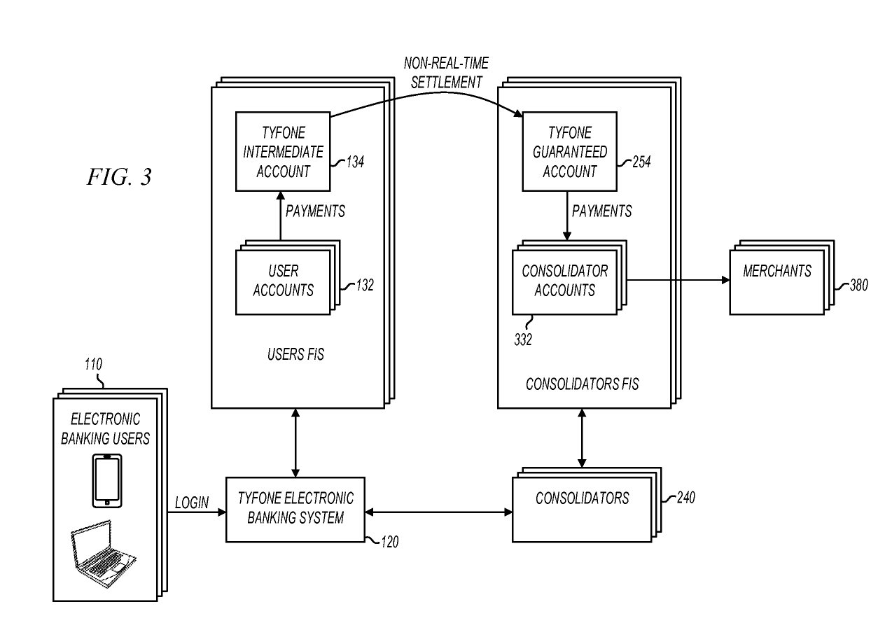

FIG. 3 shows an electronic banking system with in-application commerce between multiple banking users and multiple merchants using multiple consolidators. As shown in FIG. 3, some embodiments of the invention include relationships between any number of users, merchants, consolidators, and their respective financial institutions.

For example, electronic banking system may accept and authenticate logins from multiple users 110 for or one or more user financial institutions. Each user financial institution maintains one intermediate account 134, and when purchases are made, funds are transferred from user accounts 132 to the intermediate account 134. Further, any user at any user financial institution may make in-application purchases from any merchant 380 using any consolidator 332.

In embodiments represented by FIG. 3, non-real-time settlements occur between intermediate accounts 134 at users' financial institutions and guaranteed accounts 254 at consolidators' financial institutions. In some embodiments, consolidators are not utilized, and non-real-time settlements are made with guaranteed accounts at merchants' financial institutions as shown in FIG. 1.

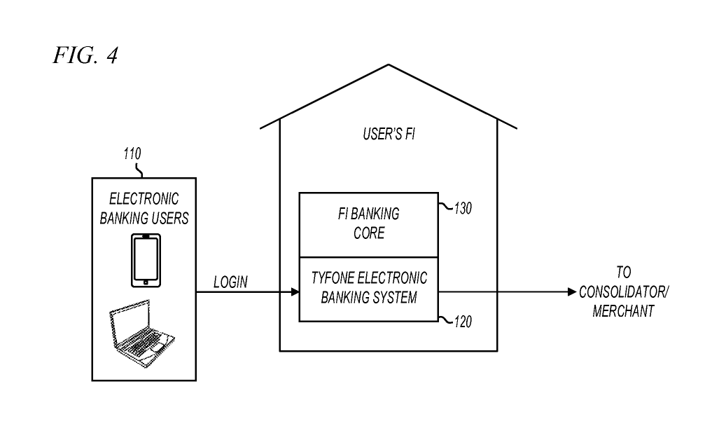

FIG. 4 shows an electronic banking system resident at a user's financial institution (FI). In embodiments represented by FIG. 4, both the electronic banking system 120 and the banking core 130 are hosted at the users' financial institution. In these embodiments, a computer system or server may perform all of the functions of the financial institution including all the functions of the electronic banking system.

For example, the user financial institution may accept and authenticate logins from users, perform funds transfers between user accounts and an intermediate account, and send messages to merchants and/or consolidators. In some embodiments the FI banking core 130 or the electronic banking system 120 or both maybe hosted outside the user's FI by a third party on behalf of the user's FI.

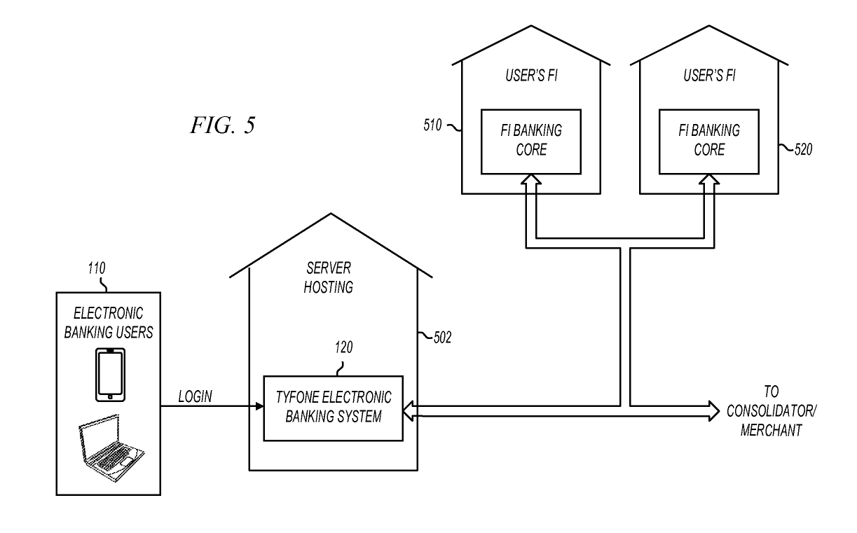

FIG. 5 shows a hosted electronic banking system that communicates with multiple different financial institutions. In embodiments represented by FIG. 5, electronic banking system 120 is hosted on a server separate from the financial institutions that are served. For example, as shown in FIG. 5, user financial institution 510 and 520 are served by the electronic banking system 120 which is hosted separately at 502. In these embodiments, electronic banking system 120 may accept and authenticate logins from users, send messages to request transfers between user accounts and intermediate accounts, and send messages to merchants and/or consolidators.

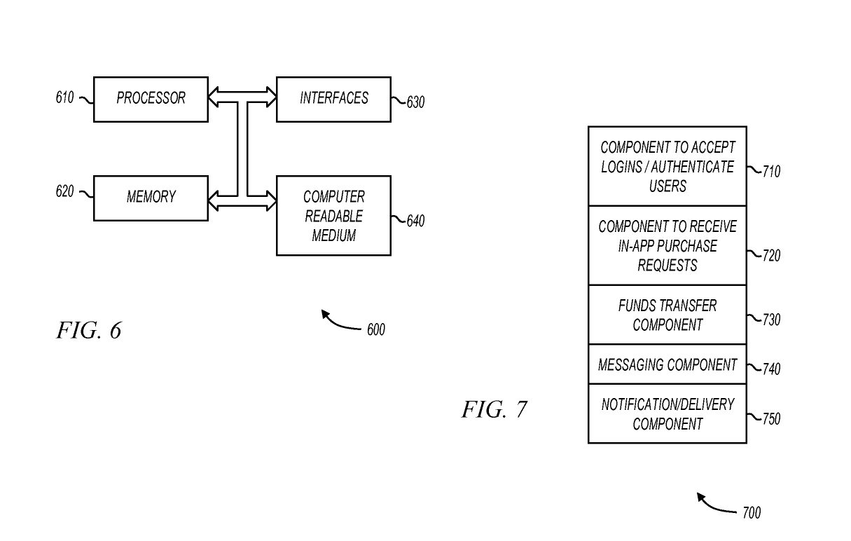

FIGS. 6 and 7 show electronic financial systems in accordance with various embodiments of the present invention. As shown in FIG. 6, electronic financial system 600 includes processor 610, memory 620, interfaces 630, and computer readable medium 640.

In some embodiments, electronic financial system 600 is embodied as electronic banking system 120 hosted at a financial institution as shown in FIGS. 1-4. In other embodiments, electronic financial system 600 is embodied as electronic banking system 120 hosted separate from a financial institution as shown in FIG. 5. In still further embodiments, electronic financial system 600 is embodied as the combination of a financial institution's banking core and electronic banking system 120 as shown in FIG. 4.

Processor 610 may include any type of processor or computer suitable to perform the functions described herein. For example, processor 610 may include a special purpose computer, or a general purpose computer that is programmed to perform as described. Memory 620 may include any type of electronic storage. For example, memory 620 may include random access memory RAM, read only memory (ROM), or any combination.

Interfaces 630 may include any type of interfaces. For example, in some embodiments, interfaces 630 include one or more network interfaces that are capable of communicating with financial institutions, merchants, and/or consolidators.

Computer readable medium 640 represents any type of medium capable of storing instructions, that when accessed by processor 610, result in the processor performing as described herein. For example, computer readable medium 640 may include any volatile or nonvolatile storage medium, including but not limited to: memory devices, magnetic disks, or optical disks.

As shown in FIG. 7, electronic financial system 700 includes a component 710 to accept logins and authenticate users, a component 720 to receive in-application purchase requests, a component 730 to transfer funds, a messaging component 740, and a notification/delivery component 750.

In some embodiments, electronic financial system 700 is embodied as electronic banking system 120 hosted at a financial institution as shown in FIGS. 1-4. In other embodiments, electronic financial system 700 is embodied as electronic banking system 120 hosted separate from a financial institution as shown in FIG. 5. In still further embodiments, electronic financial system 700 is embodied as the combination of financial institution's banking core and electronic banking system 120 as shown in FIG. 4.

The various components of electronic financial system 700 may be implemented in any manner without departing from the scope of the present invention. For example, a general purpose computer system may be programmed to embody the components shown in FIG. 7. Also for example, a special purpose computer may include a combination of hardware and software to implement the various components shown in FIG. 7.

Component 710 accepts logins and authenticates users. Referring back to FIGS. 1-3, component 710 communicates with, and authenticates users 110. In some embodiments, authentication may include detecting the presence of a smartcard secure element at the user. For example, component 710 may detect the presence of a smartcard secure element a microSD memory card in a memory slot of the user's electronic equipment.

Component 720 receives in-application purchase requests made by users. For example, a user may request to buy a physical product or a virtual coupon or gift card from within a web application or a thick application downloaded on the user's electronic equipment.

Component 730 transfers funds (or requests a funds transfer) from a user's account to an intermediate account as described with reference to FIGS. 1-3. For example, in response to component 720 receiving an in-application purchase request from a user that wishes to purchase a product from a merchant, component 730 may transfer funds from an account belonging to the user to an account belonging to an entity other than the merchant.

Messaging component 740 sends message(s) to a merchant or consolidator to request fulfillment of the in-application purchase. In response to the message, the merchant or consolidator transfers funds from a guaranteed account and then fulfills the order.

Notification/Delivery component 750 notifies the purchaser that the order had been fulfilled, or alternatively, delivers an electronic product. For example, the user may purchase a physical good that is to be shipped, and in these embodiments, component 750 notifies the user that the order has been fulfilled, and that the goods will be shipped. Also for example, the user may purchase an electronic product such as a voucher or coupon, and in these embodiments, component 750 may deliver the electronic product in the form of an email message or other notification. In some embodiments, component 750 is omitted. For example, a merchant may directly notify the user of a successful purchase.

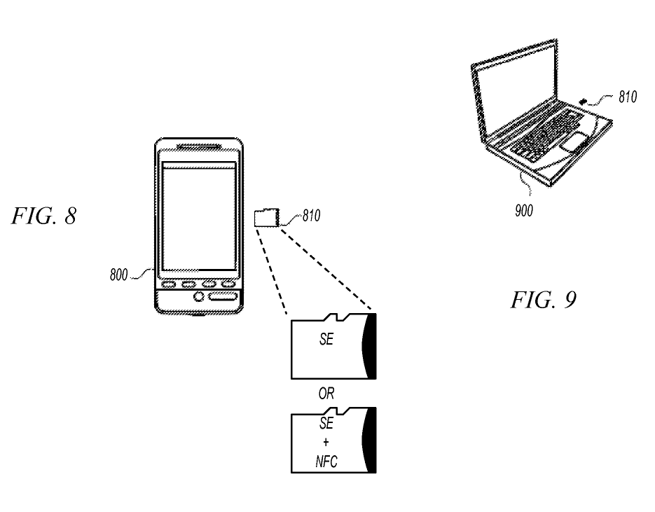

FIGS. 8 and 9 show examples of user electronic devices. FIG. 8 shows a mobile phone 800. In some embodiments, a user having mobile phone 800 logs in to a financial application at the user's financial institution and is authenticated as a valid user. In some embodiments, the mobile phone accesses the internet and the user logs in using a thin application over the web. In other embodiments, the user has downloaded a thick application to the mobile phone and the user logs in using the thick application.

In some embodiments, mobile phone 800 includes a secure element built in to the phone. For example, a smartcard secure element may be an integral part of the hardware of the phone either on the printed circuit board or inside the processor chip. In other embodiments, mobile phone 800 may include a secure element within a subscriber identity module (SIM) card that is inserted in the phone. In still further embodiments, mobile phone 800 may accept a microSD memory card 810 that includes a smartcard secure element.

In some embodiments, mobile phone 800 includes a near field communications (NFC) radio built in to the phone. For example, an NFC radio and antenna may be an integral part of the hardware of the phone. In other embodiments, mobile phone 800 may include an NFC radio within a subscriber identity module (SIM) card that is inserted in the phone. In still further embodiments, mobile phone 800 may accept a microSD memory card 810 that includes an NFC radio with or without a built-in antenna.

The use of a smartcard secure element (e.g., built-in embedded on the printed circuit board, built-in integrated inside the processor, on SIM card, or on microSD card or any other add-on form factor) may provide layered security. For example, without the smartcard secure element, authentication may only include the verification of a username and password. When the smartcard secure element is present, additional “layered” security may be provided by verifying the presence of the secure element. For example, in some embodiments, microSD card 810 may have a smartcard secure element that uniquely identifies a user, thereby providing additional assurances that the user is authentic.

The use of an NFC radio in combination with a smartcard secure element may allow for redemption of purchases at a point of sale. For example, a user may purchase a coupon or a gift car that may be redeemed by passing the phone with secure element and NFC radio near an appropriately equipped point of sale device. An example of combination secure element and NFC radio is the “SmartMX” family of controllers available from NXP Semiconductors N.V. of The Netherlands.

As shown in FIG. 9, a user may log in to an electronic financial application using a laptop computer 900. The laptop computer may have layered security just as mobile phone 800 may have layered security. In some embodiments, microSD card 810 is inserted into a card slot in laptop computer 900 for layered security. In other embodiments, a universal serial bus (USB) dongle with a smartcard secure element is inserted into a USB port to provide layered security.

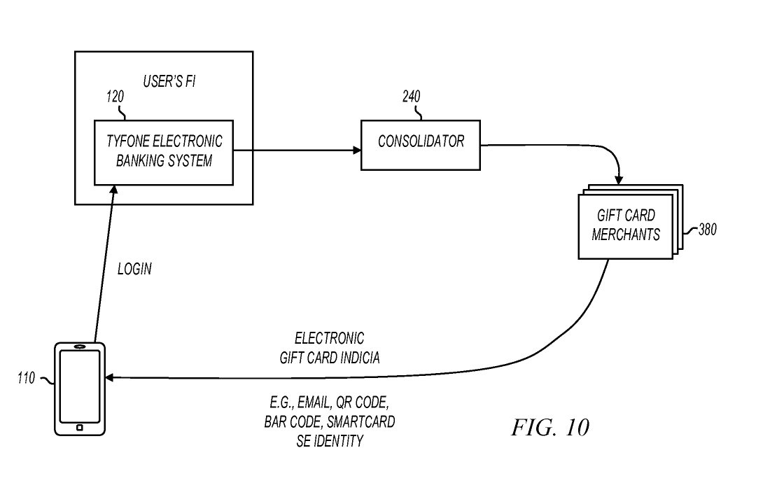

FIG. 10 shows an electronic banking system with in-application purchases of gift cards. Gift card purchases are provided as an example of in-application purchases, and the various embodiments of the invention are not so limited. Any purchase of any type of good may be made without departing from the scope of the present invention.

As shown in FIG. 10, a user 110 logs in to the electronic banking system 120 as described above. User 110 may have layered security through the use of a smartcard secure element in the phone, in a SIM card, in a microSD card, or the like.

User 110 performs in-application purchases of gift cards, and funds are transferred from the user's account at the user's financial institution to an intermediate account that does not belong to a merchant. Consolidator 240 is sent a message to fulfill the gift card orders, and then consolidator 240 communicates with merchants 380, which then fulfill the orders by sending electronic indicia of the gift cards to the user. FIG. 10 shows electronic indicia of gift cards being sent directly to the user 110, although this is not a limitation of the present invention. For example, in some embodiments, the gift card merchant communicates with the consolidator, which then in turn communicates with the electronic banking system 120, which then provides the electronic indicia of the gift cards to user 110.

The electronic indicia may be any indicia that enable use of a gift card. For example, an email with a gift card redemption code may be sent. Also for example, a one dimensional or multi-dimensional bar code may be sent. In still further examples, a quick response (QR) code may be sent. The QR code may identify a web address that houses a gift card, or the gift information may be directly encoded in the QR code.

In some embodiments, a smartcard secure element identity is provided as the electronic gift card indicia. For example, a secure element applet that may be used in near field communications (NFC) transaction at a point of sale may be provided to the user and loaded in a smartcard secure element. The smartcard secure element may be resident in the phone, on a SIM card, on a microSD card, or the like.

Although FIG. 10 shows the gift cards being delivered to the same user that purchased them, this is not a limitation of the present invention. In some embodiments, gift cards are delivered to one or more different users. For example, a gift card recipient other than user 110 may receive an email notification, a bar code, a QR code, or a smartcard secure element identity for use as a gift card.

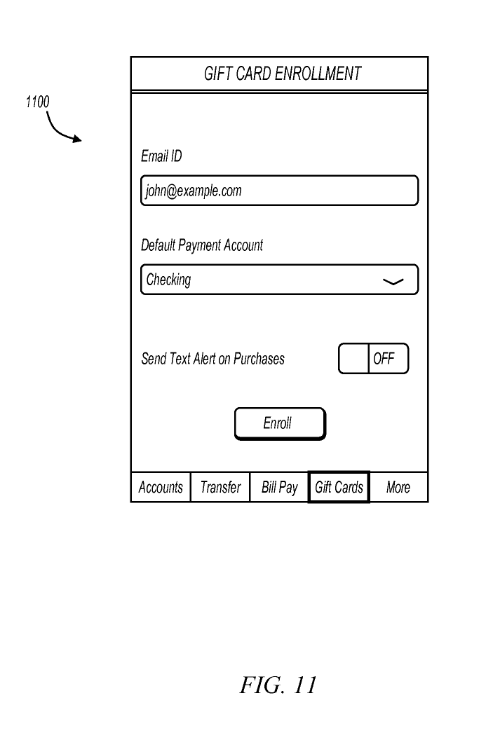

FIGS. 11-19 show mobile device displays for in-application gift card purchases. The gift card purchases shown in FIGS. 11-19 are an example of in-application purchases in accordance with various embodiments of the present invention. Gift card purchases are provided as a concrete example for explanatory purposes, and the various embodiments of the invention are not limited to gift card purchases. For example, in some embodiments, in-application purchases include purchases of physical goods such as books, clothing, furniture, auto parts, and the like. Further, in some embodiments, in-application purchases include purchases of different types of virtual goods such as streaming movies, ringtones, and the like.

The gift card purchases shown in FIGS. 11-19 are an example of in-application purchases made using a mobile device such as a mobile phone in accordance with various embodiments of the present invention. Use of a mobile device is provided as a concrete example for explanatory purposes, and the various embodiments of the invention are not limited to the use of mobile devices. For example, a user may use a laptop computer, a desktop computer, a tablet computer, or any other suitable device to login and perform in-application purchases with departing from the scope of the present invention.

FIG. 11 show an example display presented to a user to enroll in an in-application gift card purchase program in a financial application. The user enrolls by providing an email ID, and specifying a payment identity. FIG. 11 shows the payment identity as being the user's checking account. Other possibilities include savings accounts, credit cards, or any other payment account known to the user's financial institution. Note that the user enrolls without the necessity of providing a payment identity to a merchant. In this manner, in-application purchases may be made from any number of merchants without the user's payment identities being stored in multiple merchant databases.

The example financial application shown in FIG. 11 is a mobile banking application. Multiple buttons across the bottom the display provide mobile banking features that include account information, funds transfers, and bill payment, in addition to in-application purchases of gift cards.

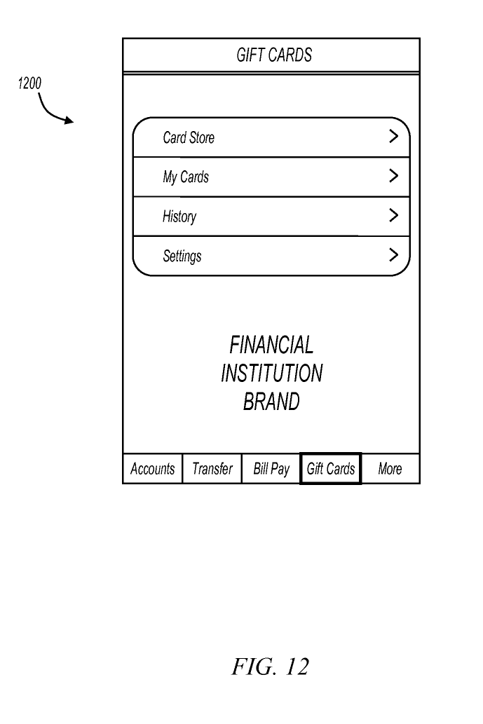

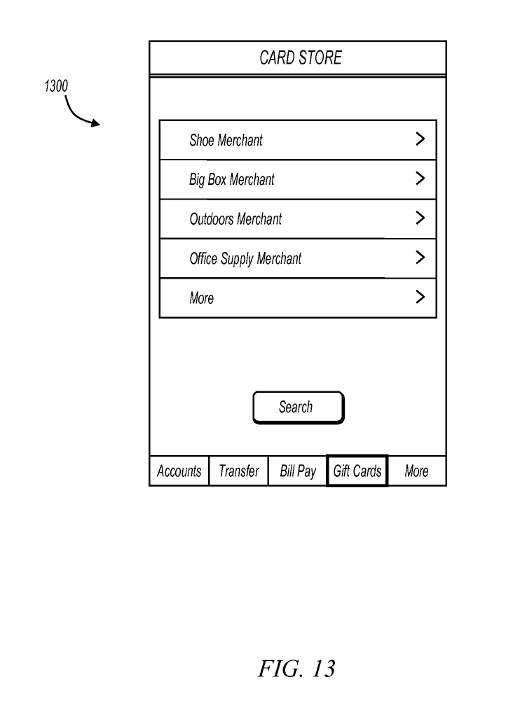

FIG. 12 shows an example display that a user may interact with after enrollment. A user may select a card store, view purchased gift cards, view history, or modify settings. FIG. 13 shows an example display that user may interact with after choosing the card store shown in FIG. 12. The card store displays gift card merchants that are part of the in-application commerce program. The first merchant shown is a shoe merchant. The remainder of the example displays assume that the user is purchasing a gift card from the shoe merchant.

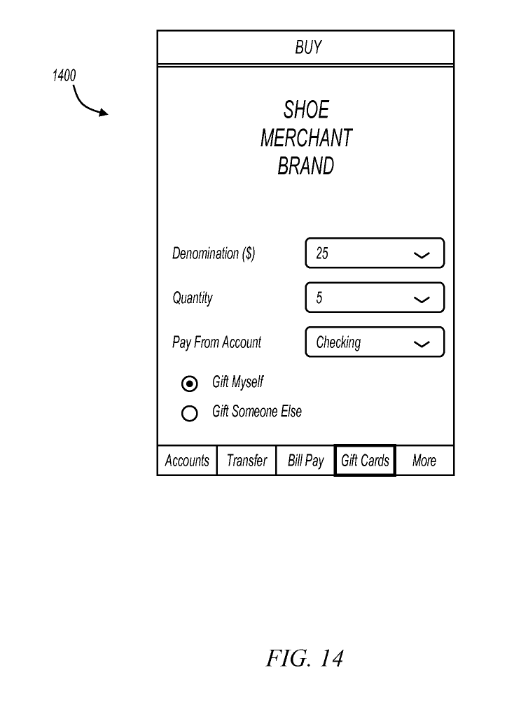

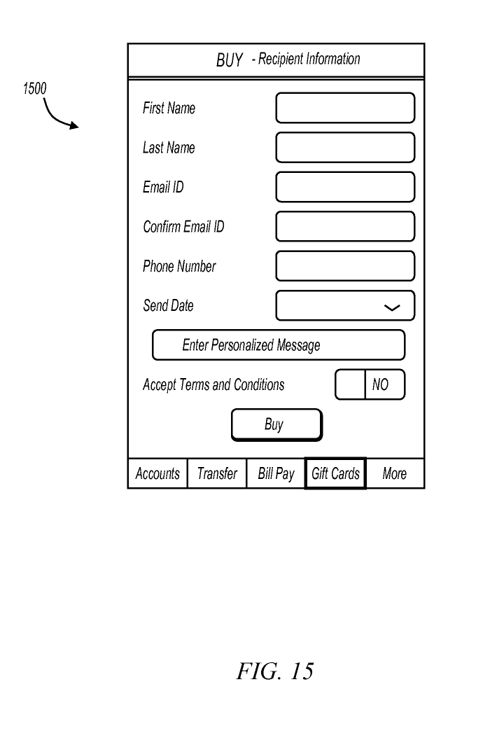

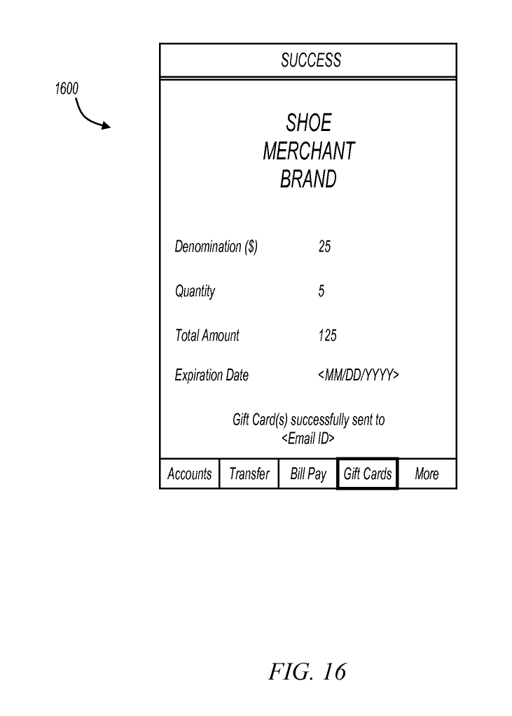

FIG. 14 shows an example display that user interacts with to purchase a gift card from a shoe merchant. The number of gift cards, the amount of each gift card, and the payment source are selected. In addition, the user may select whether to send the gift card to himself or to someone else. FIG. 15 shows a follow-on example display that a user may interact with when making an in-application gift card purchase. Further identifying information may be entered, as well as a personalized message. FIG. 16 shows an example display showing a successful in-application gift card purchase.

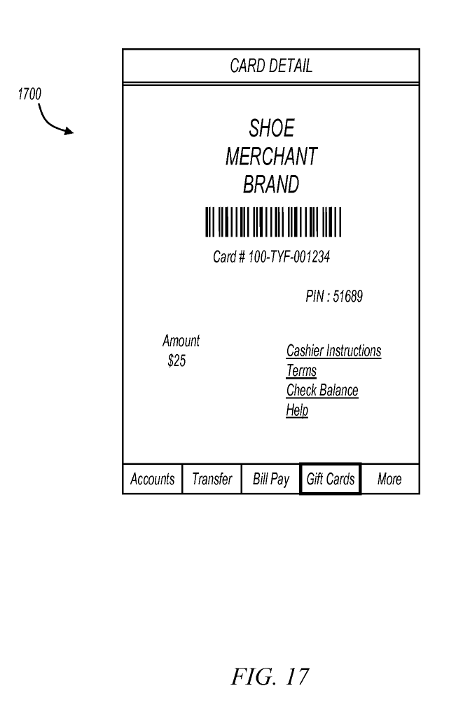

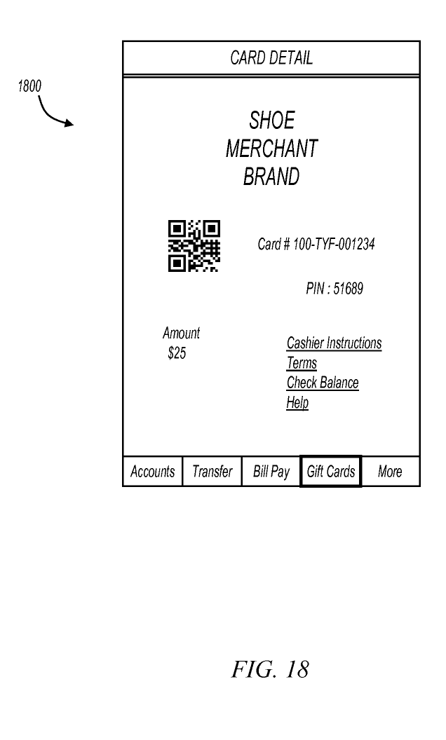

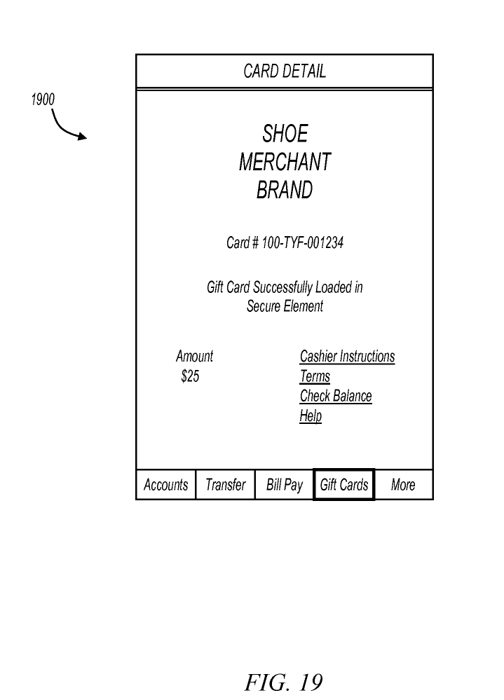

FIGS. 17-19 show example displays that correspond to electronic indicia of gift cards being sent to the user. For example, FIG. 17 shows a gift card being delivered to the user as a one dimensional bar code. FIG. 18 shows a gift card being delivered to the user as a two dimensional bar code, which in this example is a QR code. Still further, FIG. 19 shows a gift card being delivered to the user as a smartcard secure element identity. In some embodiments, the secure element is coupled to an NFC radio, and the gift card may be redeemed at a point of sale by simply passing the NFC radio near the point of sale device.

As shown in the example displays in FIG. 11-19, when performing an in-application purchase, a user selects a merchant and goods to purchase, and specifies a recipient. No payment identity need be entered because the financial institution knows the identity of the user. Payment may be made using any method known to the financial institution (e.g., debit, credit card).

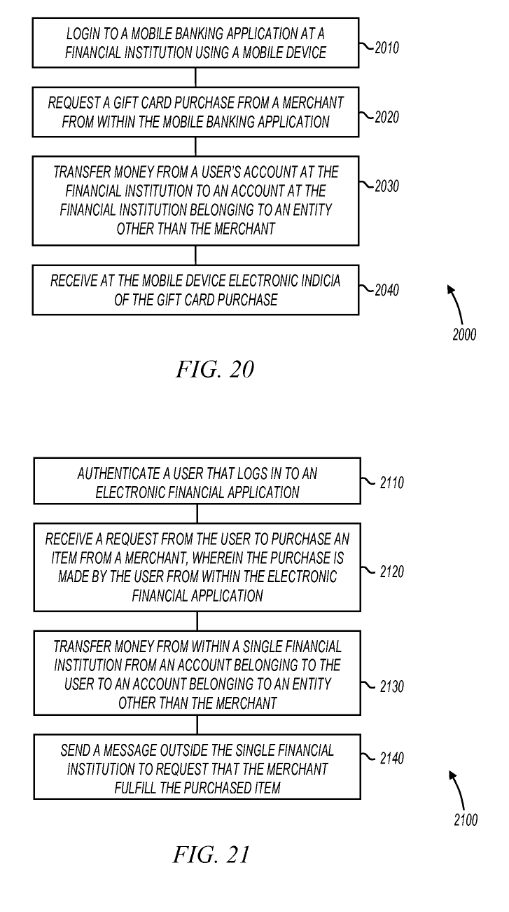

FIG. 20 shows a flowchart of methods in accordance with various embodiments of the present invention. In some embodiments, method 2000 may be performed by an electronic financial system such as system 600 (FIG. 6) or system 700 (FIG. 7). Further, in some embodiments, method 2000 maybe be performed by a financial institution such as any of the financial institutions described herein. Method 2000 is not limited by the type of system or entity that performs the method. The various actions in method 2000 may be performed in the order presented, in a different order, or simultaneously. Further, in some embodiments, some actions listed in FIG. 20 are omitted from method 2000.

Method 2000 begins at 2010 in which a user logs in to a mobile banking application at a financial institution using a mobile device. In some embodiments, the financial institution authenticates the user using only a username and password. In other embodiments, the financial institution authenticates the user using layered security by verifying the presence of a secure element at the user's electronic device.

At 2020, the user requests a gift card purchase from a merchant from within the mobile banking application. This may correspond to a user interacting with the example mobile device displays shown in FIGS. 12-16.

At 2030, money is transferred from the user's account at the financial institution to an account at the financial institution belonging to an entity other than the merchant. This corresponds to the transfer of funds to the intermediate account shown in FIGS. 1-3.

At 2040, electronic indicia of the gift card purchase is received at the mobile device. In some embodiments, the electronic indicia includes an email, a bar code, a QR code, or a smartcard secure element identity. Examples of electronic gift card indicia are shown in FIGS. 17-19.

Utilizing method 2000, a user may purchase and maintain any number of gift cards on a mobile device without divulging any payment identities to merchants when purchasing. Further, in some embodiments, gift cards are sent to individuals other than the user making the purchase.

FIG. 21 shows a flowchart of methods in accordance with various embodiments of the present invention. In some embodiments, method 2100 may be performed by an electronic financial system such as system 600 (FIG. 6) or system 700 (FIG. 7). Further, in some embodiments, method 2100 maybe be performed by a financial institution such as any of the financial institutions described herein. Method 2100 is not limited by the type of system or entity that performs the method. The various actions in method 2100 may be performed in the order presented, in a different order, or simultaneously. Further, in some embodiments, some actions listed in FIG. 21 are omitted from method 2100.

Method 2100 begins at 2110 in which a user that logs in to an electronic financial application is authenticated. This corresponds to electronic banking system 120 authenticating user 110. Authentication may be performed with only a username and password, or authentication may be more robust using layered security as described above.

At 2120, a request is received from a user to purchase an item from a merchant, where the purchase is made by the user from within the electronic financial application. The item to be purchased may be a physical good or a virtual good.

At 2130, money is transferred within a single financial institution from an account belonging to the user to an account belonging to an entity other than the merchant. In some embodiments, this corresponds to the user's financial institution transferring user funds to an intermediate account as shown in FIGS. 1-3.

At 2140, a message is sent outside the single financial institution to request that the merchant fulfill the purchased item. In some embodiments, this corresponds to sending a message directly to the merchant as shown in FIG. 1. In other embodiments, this corresponds to sending a message to a consolidator as shown in FIG. 2.

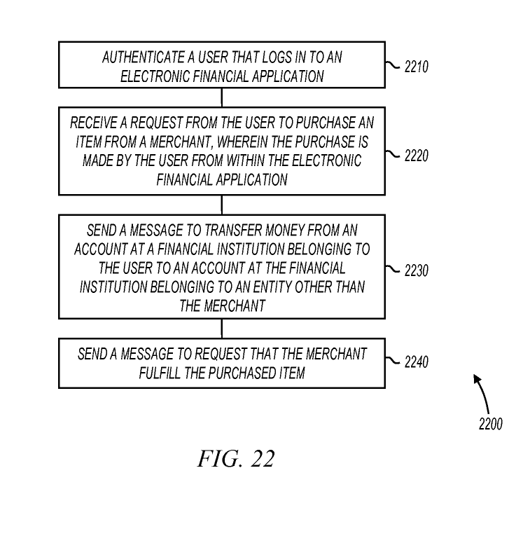

FIG. 22 shows a flowchart of methods in accordance with various embodiments of the present invention. In some embodiments, method 2200 may be performed by an electronic financial system such as system 600 (FIG. 6) or system 700 (FIG. 7). Further, in some embodiments, method 2200 maybe be performed by a financial institution such as any of the financial institutions described herein. Method 2200 is not limited by the type of system or entity that performs the method. The various actions in method 2200 may be performed in the order presented, in a different order, or simultaneously. Further, in some embodiments, some actions listed in FIG. 22 are omitted from method 2200.

Method 2200 begins at 2210 in which a user that logs in to an electronic financial application is authenticated. This corresponds to electronic banking system 120 authenticating user 110. Authentication may be performed with only a username and password, or authentication may be more robust using layered security as described above.

At 2220, a request is received from a user to purchase an item from a merchant, where the purchase is made by the user from within the electronic financial application. The item to be purchased may be a physical good or a virtual good.

At 2230, a message is sent to transfer money from an account at a financial institution belonging to the user to an account at the financial institution belonging to an entity other than the merchant. In some embodiments, this corresponds to electronic banking system 120 sending a message to a user's financial institution requesting the transfer of user funds to an intermediate account as shown in FIGS. 1-3.

At 2240, a message is sent to request that the merchant fulfill the purchased item. In some embodiments, this corresponds to sending a message directly to the merchant as shown in FIG. 1. In other embodiments, this corresponds to sending a message to a consolidator as shown in FIG. 2.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method of performing in-application transactions using a mobile device, the method comprising:
logging in to a mobile banking application at a financial institution using a mobile device;
requesting a gift card purchase from a merchant from within the mobile banking application;
in response to the request, transferring money from a user's account at the financial institution to an account at the financial institution belonging to an entity other than the merchant; and
receiving, at the mobile device, electronic indicia of the gift card purchase.

2. The method of claim 1 wherein the electronic indicia comprises a quick response (QR) code.

3. The method of claim 1 wherein the electronic indicia comprises an identity for a smartcard secure element.

4. The method of claim 1 wherein the electronic indicia comprises a bar code.

5. A method for in-application purchases comprising:
authenticating a user that logs into an electronic financial application;
receiving a request from the user to purchase an item from a merchant, wherein the request to purchase is made by the user from within the electronic financial application;
transferring money within a single financial institution from an account belonging to the user to an account belonging to an entity other than the merchant; and
sending a message outside the single financial institution to request that the merchant fulfill the purchased item.

6. The method of claim 5 wherein the electronic financial application comprises a downloadable application.

7. The method of claim 5 wherein the electronic financial application comprises a web application.

8. The method of claim 5 wherein the electronic financial application comprises an electronic banking application.

9. The method of claim 5 wherein the electronic financial application comprises a mobile banking application.

10. The method of claim 5 wherein the user is mapped to at least one payment identity at the single financial institution.

11. The method of claim 5 wherein authenticating a user comprises verifying the presence of a secure element at the user.

12. The method of claim 5 wherein authenticating a user comprises verifying the presence of a secure element in a microSD card.

13. The method of claim 5 wherein sending a message outside the single financial institution comprises sending the message to the merchant.

14. The method of claim 5 wherein sending a message outside the single financial institution comprises sending the message to a consolidator.

15. The method of claim 5 further comprising receiving from the merchant an indicia of purchase.

16. The method of claim 15 further comprising forwarding the indicia of purchase to the user.

17. The method of claim 5 further comprising:
authenticating multiple users that login to the electronic financial application;
receiving requests from the multiple users to purchase items from multiple merchants; and
sending messages to transfer money from accounts at the single financial institution belonging to the multiple users to the account at the single financial institution belonging to an entity other than the merchant.

18. A method for in-application purchases comprising:
authenticating a user that logs into an electronic financial application;
receiving a request from the user to purchase an item from a merchant, wherein the request to purchase is made by the user from within the electronic financial application;
sending a message to transfer money from an account at a financial institution belonging to the user to an account at the financial institution belonging to an entity other than the merchant; and
sending a message to request that the merchant fulfill the purchased item.

19. The method of claim 18 wherein the user is mapped to a payment identity at the financial institution.

20. The method of claim 18 wherein authenticating a user comprises verifying the presence of a secure element at the user.

21. The method of claim 18 wherein authenticating a user comprises verifying the presence of a secure element in a microSD card.

22. An electronic financial system for providing in-application purchases comprising:
a component to accept electronic logins from multiple members of a financial institution;
a component to receive purchase requests from the multiple members of the financial institution for items from a plurality of merchants; and
a funds transfer component to transfer funds from the multiple members' accounts to a single account at the financial institution to be later settled with the plurality of merchants.

23. The electronic financial system of claim 22 wherein the component to accept electronic banking logins comprises a component that accepts mobile banking logins.

24. The electronic financial system of claim 22 wherein the component to accept electronic banking logins is configured to detect the presence of secure elements at mobile devices of the multiple members.

25. The electronic financial system of claim 22 wherein the component to accept mobile banking logins is configured to detect the presence of secure elements within microSD cards at mobile devices of the multiple members.

26. The electronic financial system of claim 22 wherein the funds transfer component is configured to send a message to the financial institution to request the funds transfer.

27. A non-transitory computer readable medium having instructions stored thereon that when executed cause a computer to perform:
authenticating a user that logs into an electronic financial application;
receiving a request from the user to purchase an item from a merchant, wherein the request to purchase is made by the user from within the electronic financial application;
transferring money within a single financial institution from an account belonging to the user to an account belonging to an entity other than the merchant; and
sending a message outside the single financial institution to request that the merchant fulfill the purchased item.

28. A non-transitory computer readable medium having instructions stored thereon that when executed cause a computer to perform:
authenticating a user that logs into an electronic financial application;
receiving a request from the user to purchase an item from a merchant, wherein the request to purchase is made by the user from within the electronic financial application;
sending a message to transfer money from an account at a financial institution belonging to the user to an account at the financial institution belonging to an entity other than the merchant; and
sending a message to request that the merchant fulfill the purchased item.
